(19) United States
(12) Patent Application Publication
(10) Pub. No.: US 2015/0308337 A1
(43) Pub. Date: Oct. 29, 2015

(54) GAS TURBINE ENGINE COMPONENT WITH EMBEDDED DATA

(71) Applicant: Solar Turbines Incorporated, San Diego, CA (US)

(72) Inventors: Angelo Vincent Marasco, San Diego, CA (US); Jeffrey Stephen Carullo, San Diego, CA (US)

(73) Assignee: Solar Turbines Incorporated, San Diego, CA (US)

(21) Appl. No.: 14/263,679

(22) Filed: Apr. 28, 2014

(51) Int. Cl. F02C 7/00; G06K 19/06

(52) U.S. Cl. CPC F02C 7/00; G06K 19/06037; F05D 2240/24

(57) ABSTRACT

A component for a gas turbine engine is disclosed. The component includes at least a first portion and a second portion, and a data representing matrix. The second portion includes a second portion surface. The data representing matrix is formed directly on the second portion surface and includes a plurality of contrasting cells arranged in a geometric pattern representing information about the component including test data, a serial number, and a part number. The plurality of contrasting cells includes a plurality of first cells and a plurality of second cells that contrast from the plurality of first cells.

### TECHNICAL FIELD

The present disclosure generally pertains to gas turbine engines, and is directed toward gas turbine engine components with a representation of data pertaining to the component formed on a surface of the component to embed the data.

### BACKGROUND

Gas turbine engines include compressor, combustor, and turbine sections. The various components may be tested by a supplier for various reasons, such as quality control. This information may not be easily obtained from a supplier.

U.S. Pat. No. 6,357,420 to G. Matta discloses a method for adjusting the on-time of each hydraulically-actuated fuel injector within a hydraulically-actuated fuel injection system. At least two spray tests are performed on the fuel-injector prior to its installation in a fuel injection system. The fuel injector is marked with a bar-code capable of representing these results. Immediately prior to installing the fuel injector into the fuel injection system, the bar-code on the fuel injector is scanned and the results of the spray tests are stored in a memory unit accessible to the electronic control module. These results are used to develop a unique electronic trim solution for the fuel injector. The performance of the fuel injector is then adjusted using the electronic trim solution to enable the performance of the fuel injector to approach that of a nominal injector.

The present disclosure is directed toward overcoming one or more of the problems discovered by the inventors.

### SUMMARY OF THE DISCLOSURE

A component for a gas turbine engine is disclosed. The component includes at least a first portion and a second portion, and a data representing matrix. The second portion includes a second portion surface. The data representing matrix is formed directly on the second portion surface. The data representing matrix includes a plurality of contrasting cells arranged in a geometric pattern representing information about the component including test data, a serial number, and a part number. The plurality of contrasting cells includes a plurality of first cells and a plurality of second cells that contrast from the plurality of first cells. The plurality of contrasting cells also includes a finding pattern formed by a grouping of contrasting cells of the plurality of contrasting cells to locate and orient the data representing matrix for a data representing matrix reader.

### BRIEF DESCRIPTION OF THE DRAWINGS

FIG. 1 is a schematic illustration of an exemplary gas turbine engine.

FIG. 2 is a schematic illustration of a component for the gas turbine engine of FIG. 1.

FIG. 3 is a perspective view of an embodiment of the component of FIG. 2.

FIG. 4 is an exemplary embodiment of the data representing matrix of FIGS. 2 and 3.

FIG. 5 is a functional block diagram of a scanning system used to optically read the data representing matrix.

FIG. 6 is a flowchart of a process for utilizing the data representing matrix on the component of FIG. 2.

### DETAILED DESCRIPTION

The systems and methods disclosed herein include a component, such as a rotor blade, for a gas turbine engine. In embodiments, the component includes a data representing matrix form directly on a surface of the component. The data representing matrix includes information about the component, such as test and quality assurance data, the serial number, the part number, the manufacturing location, and the manufacturing date. A scanning system may be used by an original equipment manufacturer (OEM) to obtain the data embedded on the component in the data representing matrix. The OEM may use this information to review the test and quality assurance information and to track the component over the life of the component. The review and tracking may be automated, which may save time during assembly of the gas turbine engine and may help locate a potentially non-quality compliant component.

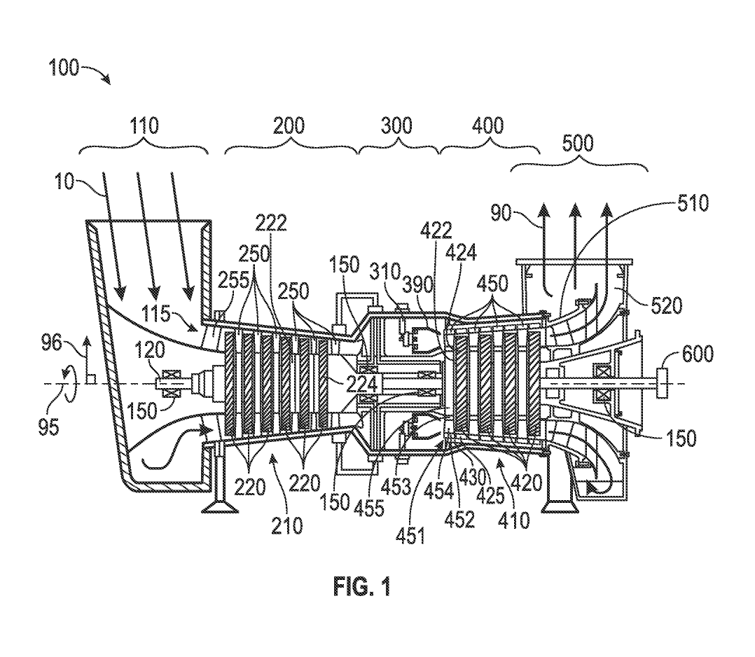

FIG. 1 is a schematic illustration of an exemplary gas turbine engine. Some of the surfaces have been left out or exaggerated (here and in other figures) for clarity and ease of explanation. Also, the disclosure may reference a forward and an aft direction. Generally, all references to “forward” and “aft” are associated with the flow direction of primary air (i.e., air used in the combustion process), unless specified otherwise. For example, forward is “upstream” relative to primary air flow, and aft is “downstream” relative to primary air flow.

In addition, the disclosure may generally reference a center axis 95 of rotation of the gas turbine engine, which may be generally defined by the longitudinal axis of its shaft 120 (supported by a plurality of bearing assemblies 150). The center axis 95 may be common to or shared with various other engine concentric components. All references to radial, axial, and circumferential directions and measures refer to center axis 95, unless specified otherwise, and terms such as “inner” and “outer” generally indicate a lesser or greater radial distance from, wherein a radial 96 may be in any direction perpendicular and radiating outward from center axis 95.

A gas turbine engine 100 includes an inlet 110, a shaft 120, a gas producer or “compressor” 200, a combustor 300, a turbine 400, an exhaust 500, and a power output coupling 600. The gas turbine engine 100 may have a single shaft or a dual shaft configuration.

The compressor 200 includes a compressor rotor assembly 210, compressor stationary vanes (“stators”) 250, and inlet guide vanes 255. The compressor rotor assembly 210 mechanically couples to shaft 120. As illustrated, the compressor rotor assembly 210 is an axial flow rotor assembly. The compressor rotor assembly 210 includes one or more compressor disk assemblies 220. Each compressor disk assembly 220 includes a compressor disk 222 that is circumferentially populated with compressor blades 224. Stators 250 axially follow each of the compressor disk assemblies 220. Each compressor disk assembly 220 paired with the adjacent stators 250 that follow the compressor disk assembly 220 is considered a compressor stage. Compressor 200 includes multiple compressor stages. Inlet guide vanes 255 axially precede the first compressor stage.

The combustor 300 includes one or more injectors 310 and includes one or more combustion chambers 390.

The turbine 400 may include a turbine housing 430, a turbine rotor assembly 410, turbine nozzles 450, and turbine diaphragms 455. Turbine housing 430 may be a solid of revolution with a hollow interior. The turbine rotor assembly 410 mechanically couples to the shaft 120 and may be located at least partially within turbine housing 430. As illustrated, the turbine rotor assembly 410 is an axial flow rotor assembly. The turbine rotor assembly 410 includes one or more turbine disk assemblies 420. Each turbine disk assembly 420 includes a turbine disk 422 that is circumferentially populated with turbine blades 424. A turbine nozzle 450 axially precedes each of the turbine disk assemblies 420. Each turbine disk assembly 420 paired with the adjacent turbine nozzle 450 that precedes the turbine disk assembly 420 is considered a turbine stage. Turbine 400 includes multiple turbine stages.

Turbine nozzles 450 may be referred to as a nozzle ring. Each turbine nozzle 450 includes multiple nozzle segments 451 grouped together to form a ring. Each nozzle segment 451 includes an outer shroud 452 an inner shroud 453, and one or more airfoils 454. Outer shroud 452 and inner shroud 453 may include a portion or a sector of an annular shape, such as a sector of a toroid or a sector of a hollow cylinder. Inner shroud 453 may be located radially inward from outer shroud 452. The one or more airfoils 454 extend radially between outer shroud 452 and inner shroud 453.

A turbine diaphragm 455 may be located radially inward from each turbine nozzle 450 and may be configured to support that turbine nozzle 450. Each nozzle segment 451 may be supported by turbine housing 430 at outer shroud 452 and by a turbine diaphragm 455 at inner shroud 453. Each turbine diaphragm 455 may be a solid of revolution with a hollow interior, such as a hollow cylinder.

The exhaust 500 includes an exhaust diffuser 510 and an exhaust collector 520.

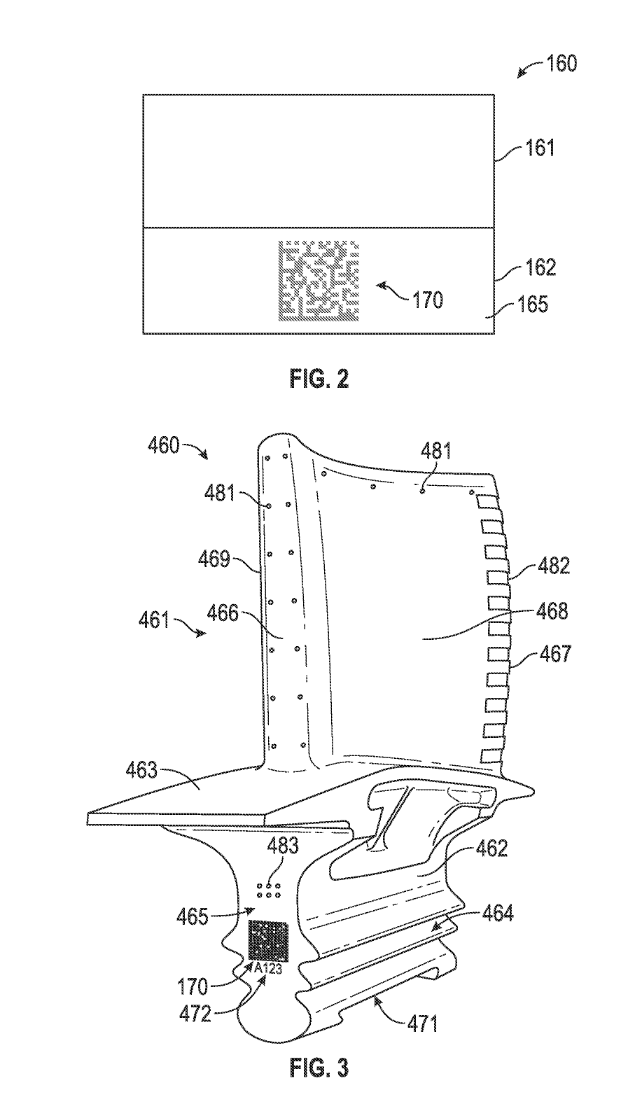

FIG. 2 is a schematic illustration of a component160 for the gas turbine engine 100 of FIG. 1. Component 160 may be a component of the compressor 200, such as a compressor disk 222, a compressor blade 224, a compressor stationary vane 250, or an inlet guide vane 255. Component 160 may also be a component of the combustor 300, such as a combustion chamber 390. Component 160 may further be a component of the turbine 400, such as a turbine disk 422, a turbine blade 424, a rotor shroud 425, a nozzle segment 451, a turbine diaphragm 455, or a turbine housing 430.

As illustrated in FIG. 2, the component 160 includes a first portion 161 and a second portion 162. Second portion 162 may be adjacent the first portion 161. Second portion 162 may be the connection end of component 160 and may be configured to connect, such as by mating or coupling to another component of gas turbine engine 100. Second portion 162 includes a second portion surface 165. Second portion surface 165 may be a surface of component 160 that is configured to not have mechanical contact with an adjacent component. Second portion surface 165 may also be a surface of component 160 that is not in a location known for environmental attack. Second portion surface 165 may further be a surface of component 160 that is in the lowest temperature region of the component 160 during operation of gas turbine engine 100. In some embodiments, second portion surface 165 does not be coated with a coating material.

Second portion 162 includes a data representing matrix 170. Data representing matrix 170 is an optical machine-readable representation of information related to component 160 marked directly on second portion surface 165, such as by shot peening, laser etching, or acid etching. Data representing matrix is not applied onto a sticker/tab that is attached or glued to second portion surface 165. Data representing matrix 170 may be a two dimensional matrix barcode, such as an Aztec code, a data matrix, a maxiCode, a PDF417, or a QR Code.

Component 160, including second portion 162 and data representing matrix 170, may not be visible during operation of gas turbine engine 100. Data representing matrix 170 may not be used solely to identify component 160; data representing matrix 170 may be used to embed information including characteristics of the component 160, such as test data.

FIG. 3 is a perspective view of an embodiment of the component 160 of FIG. 2. In the embodiment illustrated, component 160 is a rotor blade 460. Rotor blade 460 may be a compressor blade 224 or a turbine blade 424. Rotor blade 460 includes a platform 463, an airfoil 461, and a blade root 462. The platform 463 and airfoil 461 may be the first portion 161 of FIG. 2, while the blade root 462 may be the second portion 162 of FIG. 2.

Platform 463 may be a sector of a solid of revolution with a hollow interior, such as an annular shape. When rotor blade 460 is installed in a rotor disk, such as compressor disk 222 or turbine disk 422, platform 463 may be form a portion of a hot-gas duct defined by the platforms 463 of the rotor blades 460 installed in a rotor disk and a shroud, such as the rotor shroud 425 (shown in FIG. 1), located outward from the rotor blades 460.

Airfoil 461 extends in a first direction from platform 463. Airfoil 461 includes a leading edge 466, a trailing edge 467, a pressure side 468, and a suction side 469. When rotor blade 460 is installed in the rotor disk, airfoil 461 extends outward from platform 463. Pressure side 468 spans between leading edge 466 and trailing edge 467 with a concave shape. Suction side 469 is the side opposite pressure side 468 and spans between leading edge 466 and trailing edge 467 with a convex shape.

Blade root 462 extends from platform 463 in a second direction, in the direction opposite airfoil 461 or opposite the first direction. When rotor blade 460 is installed in the rotor disk, blade root 462 extends in the inward direction from platform 463. Blade root 462 is the parent component attachment piece and is configured to insert into a slot in the rotor disk. Blade root 462 may have a fir tree or a dovetail shape.

Blade root 462 may include a rotor disk contacting surface 464, a root surface 465, and a bottom surface 471. Rotor disk contacting surface 464 may be the surface of the fir tree or dovetail shape and is configured to contact the rotor disk. Root surface 465 may be the second portion surface 165 of FIG. 2. Root surface 465 may be the surface on the blade root 462 below leading edge 466 or below trailing edge 467, and may be a surface adjacent rotor disk contacting surface 464. In the embodiment illustrated, root surface 465 is the surface below the leading edge 466.

Root surface 465 may be configured to face in the axial direction when installed in a rotor disk. Root surface 465 may also be configured to not contact the rotor disk or other components of the gas turbine engine 100 when installed in the rotor disk.

Bottom surface 471 may be located at the bottom of blade root 462 and may be located distal to platform 463. Bottom surface 471 may be configured to not contact the rotor disk and may be recessed into blade root 462. In some embodiments, bottom surface 471 is the second portion surface 465.

In the embodiment illustrated, blade root 463 includes cooling passage inlets 483 extending through root surface 465. In other embodiments, cooling passage inlets 483 may be located at the bottom of blade root 463 and may extend through bottom surface 471. Cooling passage inlets 483 may be configured to receive cooling air used to cool the rotor blade 460 during operation of the gas turbine engine 100.

Rotor blade 460 also includes the data representing matrix 170. The data representing matrix 170 may be formed on the blade root 462. In the embodiment illustrated, the data representing matrix 170 is located and formed on root surface 465. In other embodiments, the data representing matrix 170 may be located and formed on other surfaces of the rotor blade 460, such as bottom surface 471. In some embodiments, data representing matrix 170 may be located on the surface that cooling passage inlets 483 extend through. In those embodiments, data representing matrix 170 may be spaced apart from the cooling passage inlets 483.

Rotor blade 460 may also include a serial number 472. Serial number 472 may be printed or formed on rotor blade 460. In the embodiment illustrated, serial number 472 is located on root surface 465. In other embodiments, serial number 472 may be located on other surfaces, such as bottom surface 471. Serial number 472 is human readable, such as an alphanumeric string. The serial number 472 may allow for a quick identification of the serial number of the rotor blade 460 with a visual inspection of the rotor blade 460, while the data representing matrix 170 may allow for a large concentration of data to be represented on a small surface area of the rotor blade 460.

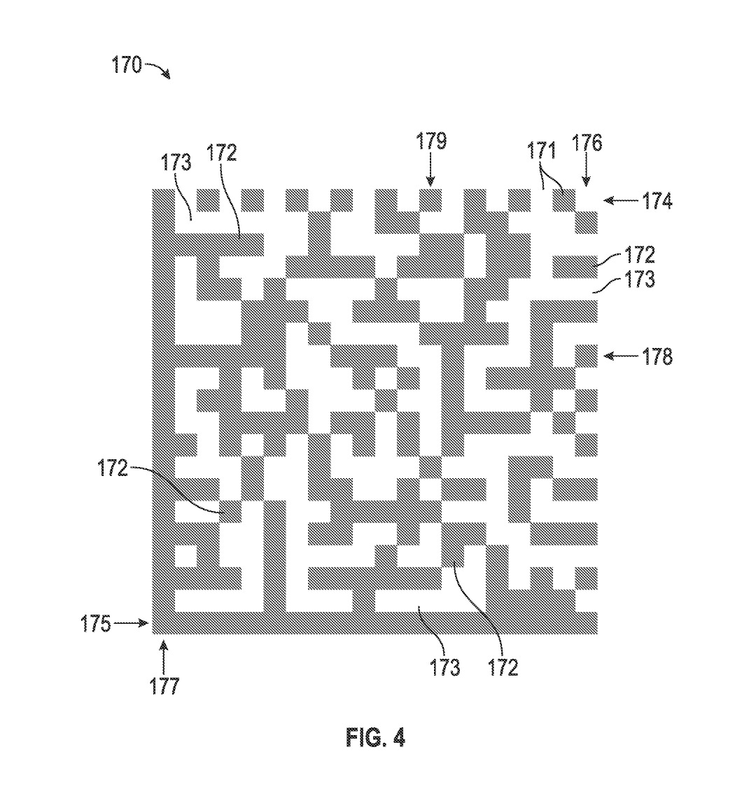

FIG. 4 is an exemplary embodiment of the data representing matrix 170 of FIGS. 2 and 3. Data representing matrix 170 may be a collection of contrasting cells 171 arranged in a pattern to represent data regarding the component 160 that the data representing matrix 170 is applied to. The contrasting cells 171 may be geometric patterns, such as squares, rectangles, triangles, pentagons, hexagons, heptagons, octagons, circles, etc. In the embodiment illustrated, the contrasting cells 171 are squares.

The contrasting cells 171 include at least two cell types. In the embodiment illustrated the data representing matrix 170 includes two cell types, first cells 172 and second cells 173. The second cells 173 contrast from the first cells 172. In some embodiments, the second cells 173 are darker than the first cells 172, while in other embodiments, the second cells 173 are lighter than the first cells 172. In some embodiments, the surface texture of the second cells 173 may be different than the surface texture of the first cells 172 to form the contrast between them. In other embodiments, the depth of the surface at second cells 173 may be different than the depth of the first cells 172 to form the contrast between them.

In some embodiment, each first cell 172 represents a zero and each second cell 173 represents a one. In other embodiments, each first cell 172 represents a one and each second cell 173 represents a zero. The contrasting cells 171 are arranged into a pattern to encode the data in a series of at least first cells 172 and second cells 173 on the second portion surface 165 of the component 160. Other encoding methodologies may also be used.

The contrasting cells 171 may be arranged in rows 178 and columns 179. In the embodiment illustrated, contrasting cells 171 are arranged into twenty rows 178 and twenty columns 179. Any number of rows 178 and columns 179 may be used and may depend on the amount of information to be represented in the data representing matrix 170. Depending on the shape of the contrasting cells 171, adjacent rows 178 may overlap and adjacent columns 179 may overlap. The contrasting cells 171, including the rows 178 and columns 179 may also be arranged to form a geometric pattern, such as a square, rectangle, triangle, pentagon, hexagon, etc.

The data representing matrix 170 may include one or more finding pattern(s). The finding pattern(s) may be used to locate the data representing matrix 170 and may be used to orient the data representing matrix 170 so that a data representing matrix reader can scan the pattern and properly convert the pattern into the data that the pattern represents. Each finding pattern may be a grouping of contrasting cells 171. In the embodiment illustrated, the data representing matrix 170 includes a first finding pattern 175 and a second finding pattern 177. As illustrated, the first finding pattern 175 is a row 178 of second cells 173 along an edge of the data representing matrix 170, and the second finding pattern 177 is a column 179 of second cells 173 along an adjacent edge of the data representing matrix 170. Other shapes, such as squares and rectangles may also be used for the finding pattern(s). The finding pattern(s) may be located along an edge, at a corner, in the center or in other locations within the data representing matrix 170.

The data representing matrix 170 may also include one or more timing pattern(s) that represent the number of rows 178 and columns 179 that are in the data representing matrix 170. The timing pattern(s) may identify a number of rows 178 and columns 179 of the data representing matrix 170 for a data representing matrix reader. Each timing pattern may be a grouping of contrasting cells 171. In the embodiment illustrated, the data representing matrix 170 includes a first timing pattern 174 representing the number of columns 179 in the data representing matrix 170, and a second timing pattern 176 representing the number of rows 178 in the data representing matrix 170.

In the embodiment illustrated, the first timing pattern 174 includes a row 178 of contrasting cells 171 alternating between second cells 173 and first cells 172 extending along the edge of the data representing matrix 170 adjacent the second finding pattern 177 and opposite the first finding pattern 175, and the second timing pattern 176 includes a column 179 of contrasting cells 171 alternating between second cells 173 and first cells 172 extending along the edge of the data representing matrix 170 adjacent the first timing pattern 174, adjacent the first finding pattern 175, and opposite the second finding pattern 177. Other shapes, such as squares and rectangles may also be used for the timing pattern(s). The timing pattern(s) may be located along an edge, at a corner, in the center or in other locations within the data representing matrix 170.

The remainder of the contrasting cells 171 may be used to encode the information/data about the component 160. In the embodiment illustrated, the remaining contrasting cells 171 are located within the boarder formed by first timing pattern 174 first finding pattern 175, second timing pattern 176, and second finding pattern 177. The data representing matrix 170 includes information about the component 160, such as the serial number, the part number, the airflow test data, the inspection data, the coating batch, the vendor code, the casting heat lot, the manufacturing location, the manufacturing date, and the microstructure orientation.

One or more of the above components (or their subcomponents) may be made from stainless steel and/or durable, high temperature materials known as “superalloys”. A superalloy, or high-performance alloy, is an alloy that exhibits excellent mechanical strength and creep resistance at high temperatures, good surface stability, and corrosion and oxidation resistance. Superalloys may include materials such as HASTELLOY, INCONEL, WASPALOY, RENE alloys, HAYNES alloys, INCOLOY, MP98T, TMS alloys, and CMSX single crystal alloys.

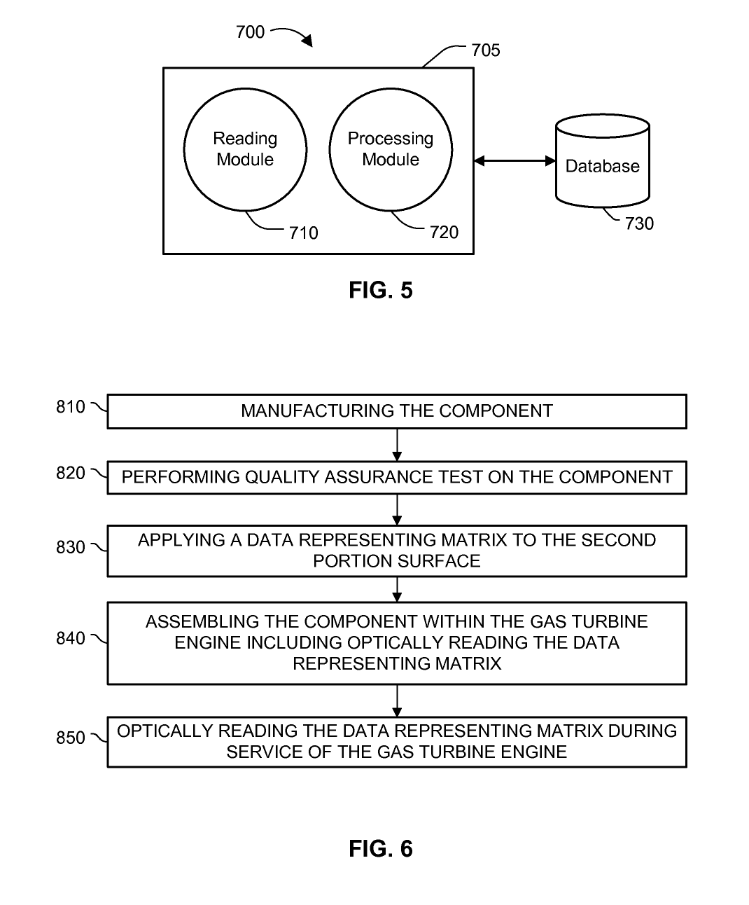

The data representing matrix 170 may be formed on second portion surface 165 during the manufacturing process, such as after quality assurance testing of the component 160. FIG. 5 is a functional block diagram of a scanning system 700 used to optically read the data representing matrix 170. The scanning system 700 may be used to optically read the data representing matrix 170 throughout the lifecycle of the component 160 to obtain the information encoded within the data representing matrix 170, such as during installation of the component 160 into the gas turbine engine 100, or during overhaul/repair of the gas turbine engine 100.

The scanning system 700 may be implemented on one or more pieces of hardware 705. Scanning system 700 includes a reading module 710 capable of optically reading the data representing matrix 170 and distinguishing between the different types of contrasting cells 171, and a processing module 720 that converts the pattern of contrasting cells 171 into the data represented by the contrasting cells 171. The hardware 705 may be implemented in various configurations, such as an optical scanner connected to a computer, or a cellular phone with an application installed for reading and converting the pattern.

The scanning system 700 may include or be connected to a database 730. The scanning system may be configured to upload all of the information encoded into the data representing matrix 170 to the database 730. In embodiments, the scanning system 700 associates the component 160 and its information from the data representing matrix 170 with the gas turbine engine 100 that the component 160 is installed into and stores that information in the database 730.

### INDUSTRIAL APPLICABILITY

Gas turbine engines may be suited for any number of industrial applications such as various aspects of the oil and gas industry (including transmission, gathering, storage, withdrawal, and lifting of oil and natural gas), the power generation industry, cogeneration, aerospace, and other transportation industries.

Referring to FIG. 1, a gas (typically air 10) enters the inlet 110 as a “working fluid”, and is compressed by the compressor 200. In the compressor 200, the working fluid is compressed in an annular flow path 115 by the series of compressor disk assemblies 220. In particular, the air 10 is compressed in numbered “stages”, the stages being associated with each compressor disk assembly 220. For example, “4th stage air” may be associated with the 4th compressor disk assembly 220 in the downstream or “aft” direction, going from the inlet 110 towards the exhaust 500). Likewise, each turbine disk assembly 420 may be associated with a numbered stage.

Once compressed air 10 leaves the compressor 200, it enters the combustor 300, where it is diffused and fuel is added. Air 10 and fuel are injected into the combustion chamber 390 via injector 310 and combusted. Energy is extracted from the combustion reaction via the turbine 400 by each stage of the series of turbine disk assemblies 420. Exhaust gas 90 may then be diffused in exhaust diffuser 510, collected and redirected. Exhaust gas 90 exits the system via an exhaust collector 520 and may be further processed (e.g., to reduce harmful emissions, and/or to recover heat from the exhaust gas 90).

Tracking a component 160 from manufacture, to installation within the gas turbine engine 100, and to removal from the gas turbine engine 100 may be difficult. There may not be a suitable mechanism for an original equipment manufacturer (OEM) to obtain the data about a component 160 from the vendor that manufactured the component 160. Thus, the data about the component including the test and quality assurance data, such as the airflow data of a rotor blade 460 may not be readily available during assembly, repair, or at other times during the life of the component 160.

Embedding this information directly onto the second surface 165 of the component 160 may allow this information to be obtained from the component 160 by anyone with a scanning system, such as the OEM. The OEM can use the scanning system to obtain the component information, upload the information into a database, and associate the component 160 with the gas turbine engine 100 it is installed into. Previously, information, such as the component serial number may be copied into a database by hand to associate the component 160 with a gas turbine engine 100 and information, such as the test and quality assurance data was not included. Embedding the information directly on the component 160 may save time as the information does not have to be input by hand and may provide more information about the component 160.

Use of the data representing matrix 170 may allow for quality assurance verification during assembly of the gas turbine engine 100. The quality assurance verification may be automated by the scanning system. For example, the airflow data for a rotor blade 460 may indicate whether the cooling passage inlets 483 and the cooling holes 481 have been properly formed in the airfoil 461.

Further, as the information in data representing matrix 170 may also include the vendor information, the manufacturing date, and the manufacturing location, any component 160 can be cross referenced against other components 160 based on that information. This may allow an OEM to locate components 160 manufactured by a certain vendor from a certain location within a given time frame and to track the components 160 over the OEMs entire fleet. Further, the database can then be used to perform subsequent quality assurance verification checks for any combination of criteria based on the information encoded within the data representing matrix 170.

FIG. 6 is a flowchart of a process for utilizing the data representing matrix on the component of FIG. 2. The process includes manufacturing the component 160 at step 810. The process also includes performing quality assurance test on the component 160 at step 820. In some embodiments, this includes performing airflow tests on the component 160. The process further includes applying a data representing matrix 170 to the second portion surface 165 at step 830. The data representing matrix 170 represents at least the test data and the serial number of the component 160.

The process yet further includes assembling the component 160 within the gas turbine engine 100 at step 840. Step 840 includes optically reading the data representing matrix 170 with the scanning system 700 and storing the information contained within the data representing matrix 170 in the database 730. Step 840 may also include associating the serial number of the component 160 with the gas turbine engine 100.

The process may still further include optically reading the data representing matrix 170 during service of the gas turbine engine 100 at step 850, such as during overhaul or repair of the gas turbine engine 100. Step 850 may include disassociating the serial number of the component 160 when it is permanently removed from the gas turbine engine 100.

Those of skill will appreciate that the various illustrative logical blocks, modules, and algorithm steps described in connection with the embodiments of the scanning system disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the design constraints imposed on the overall system. Skilled persons can implement the described functionality in varying ways for each particular application, but such implementation decisions should not be interpreted as causing a departure from the scope of the invention. In addition, the grouping of functions within a module, block, or step is for ease of description. Specific functions or steps can be moved from one module or block without departing from the invention.

The various illustrative functional blocks and modules described in connection with the embodiments of the scanning system disclosed herein can be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or operation the embodiments of the scanning system disclosed herein can be embodied directly in hardware, in a software module executed by a processor (e.g., of a computer), or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

The preceding detailed description is merely exemplary in nature and is not intended to limit the invention or the application and uses of the invention. The described embodiments are not limited to use in conjunction with a particular type of gas turbine engine. Hence, although the present disclosure, for convenience of explanation, depicts and describes particular components for a gas turbine engine, it will be appreciated that the components in accordance with this disclosure can be implemented in various other configurations, can be used with various other types of gas turbine engines, and can be used in other types of machines. Furthermore, there is no intention to be bound by any theory presented in the preceding background or detailed description. It is also understood that the illustrations may include exaggerated dimensions to better illustrate the referenced items shown, and are not consider limiting unless expressly stated as such.

What is claimed is:

1. A component for a gas turbine engine, the component comprising:
at least a first portion and a second portion, the second portion being a connection end of the component and including a second portion surface; and
a data representing matrix formed directly on the second portion surface, the data representing matrix including
a plurality of contrasting cells arranged in a geometric pattern representing information about the component including test data, a serial number, and a part number, the plurality of contrasting cells including
a plurality of first cells, and
a plurality of second cells that contrast from the plurality of first cells, and
a finding pattern formed by a grouping of contrasting cells of the plurality of contrasting cells to locate and orient the data representing matrix for a data representing matrix reader.

2. The component of claim 1, wherein the plurality of second cells are darker than the plurality of first cells.

3. The component of claim 2, wherein the plurality of first cells represent a one and the plurality of second cells represent a zero.

4. The component of claim 2, wherein the finding pattern is a row of second cells extending along an edge of the geometric pattern.

5. The component of claim 1, wherein each contrasting cell of the plurality of contrasting cells is a square, and the plurality of contrasting cells is arranged in rows and columns forming a second square.

6. The component of claim 1, wherein the data representing matrix also includes a timing pattern formed by a second grouping of contrasting cells of the plurality of contrasting cells to represent the number of rows and columns of the data representing matrix.

7. The component of claim 1, wherein the plurality of contrasting cells are also arranged to represent a manufacturing date of the component, a manufacturing location of the component, and a casting heat lot of the component.

8. The component of claim 1, wherein the second portion surface and the data representing matrix is not coated by a coating material.

9. A gas turbine engine including the component of claim 1, wherein the second portion surface does not contact other components of the gas turbine engine, and the second portion surface is located at the lowest temperature region of the component during operation of the gas turbine engine.

10. A rotor blade for a gas turbine engine including a rotor disk, the rotor blade comprising:
a platform;
an airfoil extending from the platform in a first direction, the airfoil including
a leading edge,
a trailing edge,
a pressure side extending from the leading edge to the trailing edge, and
a suction side opposite the pressure side extending from the leading edge to the trailing edge;
a blade root extending from the platform in a second direction, opposite the first direction, the blade root including
a rotor disk contacting surface that contacts the rotor disk when the rotor blade is installed in the gas turbine engine, and
a root surface adjacent the rotor disk contacting surface; and
a data representing matrix formed on the blade root, the data representing matrix being an optical machine-readable representation of information about the rotor blade including airflow data, a serial number, and a part number formed on the root surface.

11. The rotor blade of claim 10, wherein the data representing matrix includes a plurality of contrasting cells arranged in a pattern, the plurality of contrasting cells including
a plurality of first cells, and
a plurality of second cells that contrast from the plurality of first cells.

12. The rotor blade of claim 11, wherein the data representing matrix includes a finding pattern formed by a grouping of contrasting cells of the plurality of contrasting cells to locate and orient the data representing matrix for a data representing matrix reader.

13. The rotor blade of claim 12, wherein the data representing matrix also includes a timing pattern formed by a second grouping of contrasting cells of the plurality of contrasting cells to represent the number of rows and columns of the data representing matrix.

14. The rotor blade of claim 11, wherein the plurality of second cells include a different surface texture than the plurality of first cells.

15. The rotor blade of claim 11, wherein each contrasting cell of the plurality of contrasting cells is a square, and the plurality of contrasting cells is arranged in rows and columns forming a second square.

16. The rotor blade of claim 10, wherein the data representing matrix is located and formed on the root surface.

17. The rotor blade of claim 16, wherein the rotor disk contacting surface is coated with a coating material and the root surface is not coated with the coating material.

18. A gas turbine engine including the rotor blade of claim 10, the gas turbine engine further comprising a shaft and a rotor disk coupled to the shaft, wherein the rotor blade is coupled to the rotor disk and the root surface does not contact the rotor disk.

19. A data representing matrix formed on a root surface of a rotor blade for a gas turbine engine, the data representing matrix comprising:
a plurality of first cells;
a plurality of second cells with a different surface texture than the plurality of first cells to contrast the plurality of second cells from the plurality of first cells;
a finding pattern formed by an optical and machine-readable grouping of second cells of the plurality of second cells to locate and orient the data representing matrix for a data representing matrix reader;
a timing pattern formed by an optical and machine-readable grouping of alternating first cells of the plurality of first cells and second cells of the plurality of second cells to identify a number of rows and columns of the data representing matrix for the data representing matrix reader; and
a remainder of the plurality of first cells and the plurality of second cells arranged in an optical and machine-readable geometric pattern representing information about the rotor blade including airflow data, a serial number, and a part number.

20. The data representing matrix of claim 19, wherein the plurality of first cells and the plurality of second cells are arranged in rows and columns.
